(19) United States
(12) Patent Application Publication
(10) Pub. No.: US 2021/0194685 A1
(43) Pub. Date: Jun. 24, 2021

(54) SYSTEM AND METHOD FOR SECURE COMMUNICATIONS AMONG MULTIPLE DEVICES

(71) Applicant: Enlighted, Inc., Sunnyvale, CA (US)

(72) Inventors: Sanjeev Patel, Santa Clara, CA (US); Evan Danny Petridis, Palo Alto, CA (US)

(21) Appl. No.: 16/721,756

(22) Filed: Dec. 19, 2019

(51) Int. Cl. H04L 9/08; H04W 12/08; H04L 9/14; H04W 12/06

(52) U.S. Cl. CPC H04L 9/0866; H04L 9/0825; H04W 12/06; H04L 9/14; H04L 9/0847; H04W 12/08

(57) ABSTRACT

There is described a building management system for secure communications among a mobile device, a sensor, and a remote server. The mobile device broadcasts a beacon that includes an obfuscated identification and a first ciphertext. The sensor receives the beacon from the mobile device, generates an identity-based key based on the obfuscated identification, determines a first plain text by decrypting the first ciphertext using the identity-based key, and performs a sensor function based on at least a portion of the first plain text. The remote server receives a message from the sensor that includes a second ciphertext based at least in part on the first plain text. The remote server also generates a real identity based on the obfuscated identification, determines a second plain text based on the second ciphertext, and performs a server function based on at least a portion of the second plain text.

### FIELD OF THE INVENTION

This application relates to the field of building management systems and, more particularly, building management systems and methods for protecting security and anonymity of tracked assets.

### BACKGROUND

Building management systems encompass a wide variety of systems that aid in monitoring and controlling of various aspects of facility operation. Building management systems may include one or more specialized subsystems, such as a security subsystem, a fire safety subsystem, a lighting subsystem, and a heating, ventilation, and air conditioning (“HVAC”) subsystem. The building devices managed by the system, such as lighting fixtures and motion detectors, may be widely dispersed throughout the facility and managed by a centralized control station. The systems may include portable devices carried by building occupants to track their locations, thus enhancing the ability of the systems to manage the specialized subsystems for the comfort and benefit of the building occupants.

Portable device may emit wireless signals that are susceptible to security and privacy attacks. For communications between a portable device to a cloud-based hub, protection for the content of wireless signals is available in which intermediate devices may be blocked from accessing the content. For example, ephemeral identifier systems assume that all data processing can happen in a centralized location, such as the cloud, and require all data to be sent to the cloud as a result. For asset tracking in a system of distributed intermediate devices, the intermediate devices may have a need or desire to access the content of wireless signals to the benefit of the system operator and/or building occupants. Unfortunately, the effectiveness of intermediate devices of an ephemeral identifier system in this regard may be constrained.

### SUMMARY

In accordance with one embodiment of the disclosure, there is provided a secure approach for communications between portable devices and a central station of a building management system in which intermediate devices may access the communications while maintaining the security and/or anonymity of these communications. In addition, techniques described herein may further enhance efficiency and cost of the building management system by limiting the amount of data backhauled to the central station, thus reducing the demands on connecting networks and minimizing the cost of networking technologies required for the devices. A handler of one or more intermediate devices include security features required to maintain the obfuscation of the communications while handling the communicated data so that the devices may utilize data. For example, the handler may prioritize or otherwise select important information of the portable devices to be forwarded to the central station, such as certain battery status or user emergencies, while maintaining the security of such information.

One aspect is a building management system for secure communications among multiple devices. The system comprises a mobile device, a sensor, and a remote server. The mobile device is configured to broadcast a beacon, in which the beacon includes an obfuscated identification and a first ciphertext. The sensor is configured to receive the beacon from the mobile device. The sensor generates an identity-based key based on the obfuscated identification, determines a first plain text based on the first ciphertext by decrypting the first ciphertext of the beacon using the identity-based key, and performs one or more sensor functions based on at least a portion of the first plain text. The remote server is configured to receive a message from the sensor, in which the message includes a second ciphertext based at least in part on the first plain text. The remote server generates a real identity based on the obfuscated identification, determines a second plain text based on the second ciphertext, and performs one or more server functions based on at least a portion of the second plain text.

Another aspect is a sensor of a building management system for secure communication from a mobile device to a remote server. The building management system comprises a communication component and a processor. The communication component is configured to receive a beacon from the mobile device and transmits a message to the remote server. The beacon includes an obfuscated identification and a first ciphertext. The message includes a second ciphertext based at least in part on a plain text determined from the first ciphertext. The processor is configured to generate an identity-based key based on the obfuscated identification, determine the plain text based on the first ciphertext by decrypting the first ciphertext of the beacon using the identity-based key, and perform one or more sensor functions based on at least a portion of the plain text.

Yet another aspect is a method a sensor of a building management system for secure communication from a mobile device to a remote server. The sensor receives a beacon from the mobile device. The sensor identifies an obfuscated identification and a first ciphertext from the beacon. The sensor then generates an identity-based key based on the obfuscated identification. Next, the sensor determines a plain text based on the first ciphertext. Determining the plain text includes decrypting the first ciphertext of the beacon using the identity-based key. The sensor then performs one or more sensor functions based on at least a portion of the plain text. The sensor also transmits a message to the remote server, in which the message includes a second ciphertext based at least in part on the plain text.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is an illustration of an example implementation of a building management system that is operable to employ techniques described herein.

FIG. 2 is a flow diagram depicting an example operation of the mobile device of FIG. 1 to employ the techniques described herein.

FIG. 3 is a block diagram of an example implementation of the mobile device of FIG. 1.

FIGS. 4A and 4B are flow diagrams depicting an example operation of one or more of the sensors of FIG. 1 to employ the techniques described herein.

FIG. 5 is a block diagram of an example implementation of the sensor of FIG. 1.

FIG. 6 is a flow diagram depicting an example operation of the remote server of FIG. 1 to employ the techniques described herein.

FIG. 7 is a block diagram of an example implementation of the remote server of FIG. 1.

### DETAILED DESCRIPTION

Various technologies that pertain to systems and methods that facilitate intermediate access of secure communications among multiple devices of a building management system will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

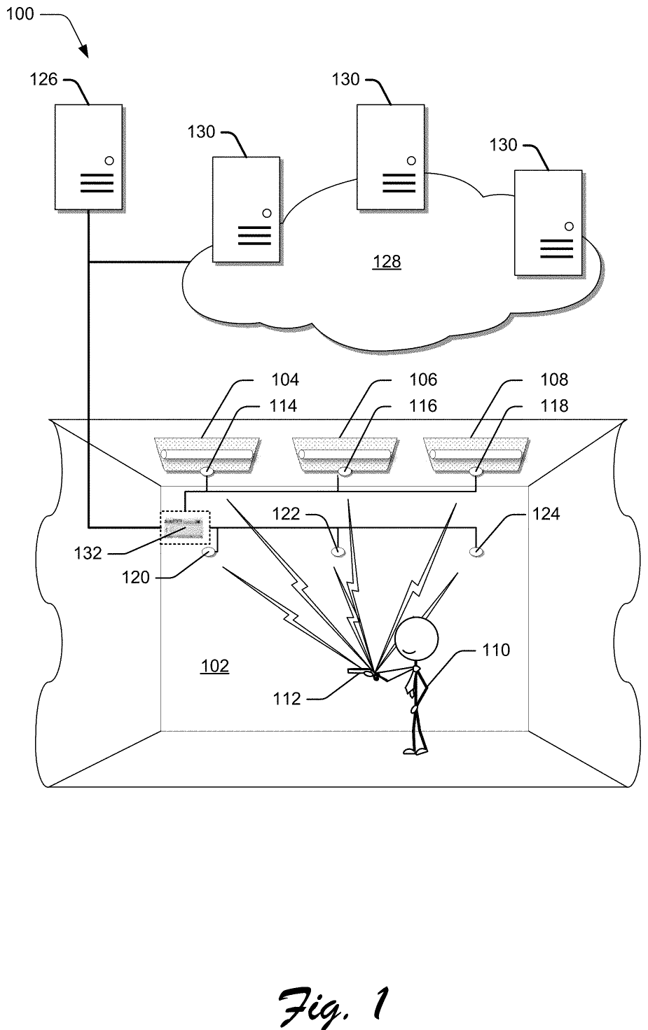

FIG. 1 illustrates an example implementation of a building management system 100 for communications between portable devices and a central station in which intermediate devices may access the communications while maintaining the security and/or anonymity of these communications. The portable devices may be any type of transportable device capable of wireless communication with one or more intermediate devices of the system, such as transmission of a beacon. Examples of mobile devices include, but are not limited to, tags, wearables, wireless communication devices, tablets, portable computing devices, and any other type of transportable device including circuitry for wireless communications. The intermediate devices may be any type of fixed or affixable device capable of wireless communication with one or more mobile devices of the system, such as receipt of a beacon, as well as wired or wireless communication with the central station. Examples of intermediate devices include, but are not limited to, independent devices or devices deployed with appliances (such as light fixtures) including circuitry for wireless communications and security functions. Wireless communications include, but are not limited to, Bluetooth (including BLE), Wi-Fi (including Wi-Fi Direct), Zigbee, Z-Wave, 6LoWPAN, Near-Field Communication, other types of electromagnetic radiation of a radio frequency wave, light-based communications (including infrared), acoustic communications, and any other type of peer-to-peer technology, may be utilized for implementing the techniques described herein. The central station may be any type of device located remote from one or more intermediate devices and capable of communication with the intermediate devices of the system. An example of a central station includes, but is not limited to, a server, a group of servers (such as a cloud), a desktop computer, a portable computer, a mobile device, and any other type of computing device including circuitry for wired or wireless communications and security functions.

Referring to FIG. 1, the building management system 100 illustrates an example area 102 of a facility to illustrate an aspect of secure communications among the various devices of the system 100. For this example implementation 100, environmental devices, such as light fixtures 104-108, are installed at a ceiling of the area 102. Examples of environmental devices include, but are not limited to, light fixtures 104-108, air vents, window blinds/shades, smoke detectors, security cameras, and the like. The example implementation 100 also shows an occupant 110 of the facility and a mobile device 112 associated with the occupant 110. For example, the mobile device 112 may be carried, supported, or otherwise co-located with the occupant 110 such that the location of the mobile device may be associated with the location of the occupant 110.

In addition to the environmental devices, the area 102 includes intermediate devices, such as sensors 114-124, positioned at various locations of the area 102. Intermediate devices may be positioned anywhere within an area or facility of interest. For example, as shown in FIG. 1, some sensors 114-118 may be fixed or otherwise positioned at the ceiling of the area 102, and other sensors 120-124 may be fixed or otherwise positioned at a wall of the area 102. Also, sensors 114-118 may be co-located or adjacent to environmental devices and/or sensors 120-124 may be positioned independent of the environmental devices. The intermediate devices, such as the sensors 114-124, may have locations at the ceiling, walls, and other parts of the area 102 of the facility so that the intermediate devices may receive beacons broadcast from the mobile devices 112 in proximity to the intermediate devices.

One or more central stations are located remote from the intermediate devices and communicate with the intermediate devices via wired or wireless communications. For some embodiments, one or more central stations may be located remote from all intermediate devices, such as a remote location of a facility or outside of the facility. For example, the central station may be a server 126 located at a central computer area of the facility or a cloud 128 including multiple servers 130 that communicate with the intermediate devices via a communications network. For other embodiments, the central station may be located remote from some intermediate devices but not others. For example, the central station, such as the server 126, may be located in a central area with some intermediate devices while communicating with other intermediate devices in other areas 102 of the facility.

The building management system 100 may optionally include one or more wired or wireless gateways 132 positioned among the intermediate devices, such as the sensors 114-124, at the facility in which each wired or wireless gateways may serve as a communication transponder between the central station or stations and the intermediate devices.

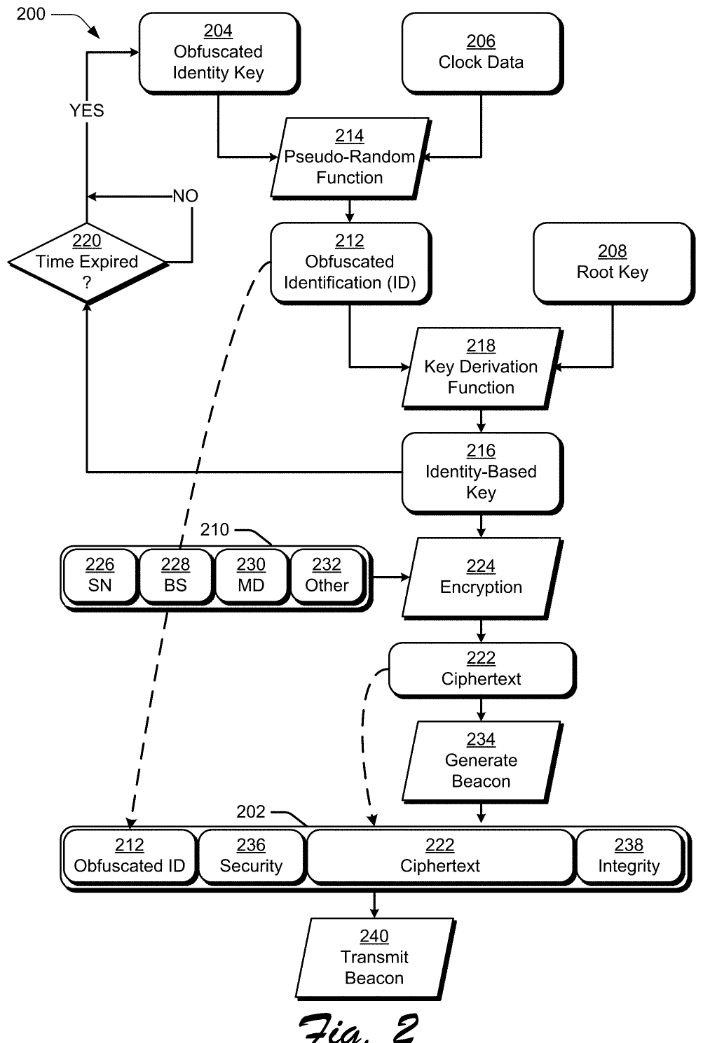

Referring to FIG. 2, there is shown a flow diagram depicting an example operation 200 of one or more mobile devices 112 of the building management system 100. Each mobile device 112 generates a beacon 202 based on an obfuscated identity key 204, clock data 206, a root key 208, and a first plain text 210 including data that may be useful to the intermediate devices, such as sensors 114-124, and the central station(s) 126-130. The identity, i.e., identification, of the mobile devices 112 is obfuscated in the transmitted beacons, and other beacon data is encrypted in a way that prevents traceability of the identity of the mobile device 112 but allows processing on intermediate devices. Each mobile device 112 includes a unique obfuscated identity key 204, i.e., unique to the mobile device 112. The obfuscated identity key 204 may be provided to the mobile device 112 via a provisioning process at an on-site location (i.e., at the facility), at a factory during manufacture or packaging, or some other secure and convenient location (i.e., in the field). For example, a provisioning device may include a mobile app or a web user interface that connects to the mobile device via a wireless link and imprints the obfuscated identity key 204 while communicating with the cloud 128 for cloud coordination.

Each mobile device 112 may generate an obfuscated identification 212 based on the obfuscated identity key 204 and properties of the device using a pseudo-random function 214. When the mobile device 112 is provisioned, the device is provisioned with an initial version of the obfuscated identity key 204 which is used to determine the first obfuscated identification 212 when the process is initiated. The properties of the mobile device 112 may include time-based properties, such as the clock data 206, to facilitate the determination of the obfuscated identification 212 by the pseudo-random function 214. In turn, each mobile device 112 may generate an identity-based key 216 based on the obfuscated identification 212 and the root key 208 using a key derivation function 218. The root key 208 is known by the mobile devices 112 and the intermediate devices. The key derivation function 218 derives one or more secret keys from a secret value such as a master key, a password, or a passphrase using a pseudorandom function 214.

For security, each mobile device 112 generates an alias that changes on a periodic basis in a way that is predictable for the intermediate devices and the central station, but not for other devices. The mobile device 112 repeats this flow of generating the obfuscated identification, generating the identity-based key, and updating the obfuscated identity key over a period of time, thus rotating every tick. For example, the timing for each tick may be based on a power of 2, in seconds, such as 8 seconds, 16, second, or 32 seconds. Some embodiments may include a timing circuit to determine 220 when the predetermined time period has expired. In this manner, a new obfuscated identification, obfuscated identity key, and obfuscated identity key may be generated for every tick.

The mobile device 112 may encrypt the first plain text 210 in response to determining the identity-based key 216. In particular, the mobile device 112 may generate a first ciphertext 222 from the first plain text 210 by encrypting 224 the first plain text using the identity-based key 216. The encryption function 224 may be based on the Advanced Encryption Standard, the Data Encryption Standard, or other specifications for the encryption of electronic data, such as AES128. The first plain text 210 includes data that may be useful to the intermediate devices and the central station(s) 126-130. Examples of the first plain text 210 include, but are not limited to, a sequence number (SN) 226, a battery status (BS) 228, a motion datum (MD) 230, and/or other types of data 232 such as telemetry datum. For example, the first plain text 210 may include an indicator that a user interface associated with an emergency or urgent condition has been selected by a user at the mobile device.

The mobile device 112 may generate 234 the beacon 202 in response to encrypting the first plain text 210 and generating the first ciphertext 222. The beacon 202 may include a beacon identifier, such as the obfuscated identification 212 generated by the pseudo-random function 214, and a payload that includes the first ciphertext 222 that is encrypted 224 based on the first plain text 210 and the identity-based key 216. The beacon 202 may also include other data to maintain the quality of the payload, such as security data 236 (e.g., nonce) to protect the payload and/or integrity data 238 (e.g., message integrity check) to minimize errors in transport. Thereafter, the mobile device 112 may broadcast the beacon 202, thus transmitting the beacon 202 to any intermediate device in proximity to the mobile device 112. In this manner, each mobile device 112 is configured to broadcast a beacon 202 that includes the obfuscated identification 212 and the first ciphertext 222.

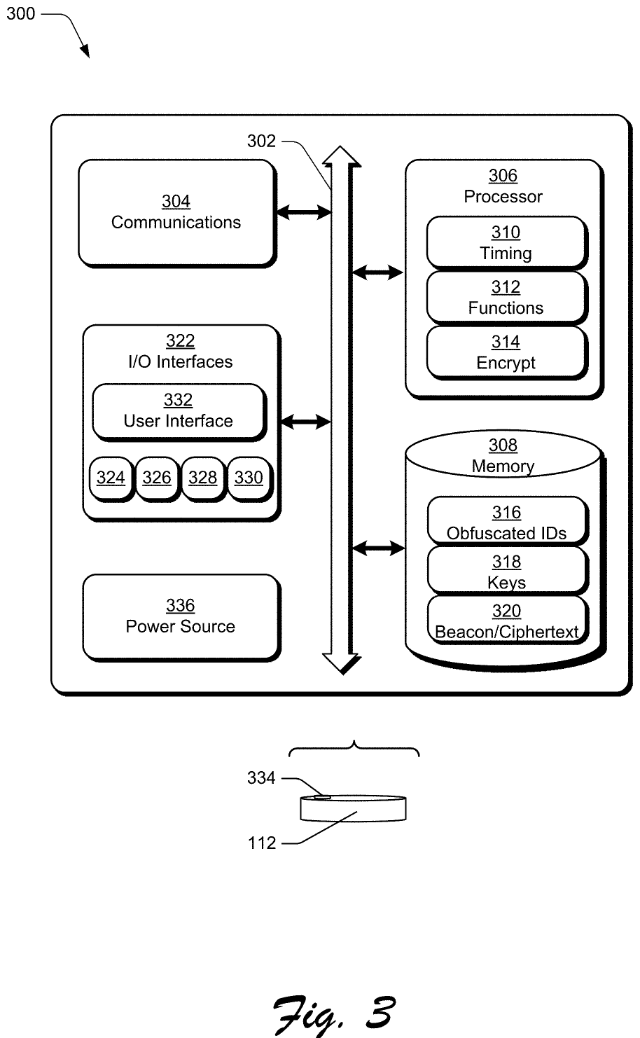

FIG. 3 represents example device components 300 of the mobile device 112 of the building management system 100. An example of a mobile device 112 includes, but is not limited to, a tag, a wearable, a wireless communication device, a tablet, a portable computing device, and any other type of transportable device having wireless communication capabilities. The device components 300 of the mobile device 112 comprise a communication bus 302 for interconnecting the other device components directly or indirectly, one or more communication components 304 communicating other entities via a wired or wireless network, one or more processors 306, and one or more memory components 308. The communication component 304 may utilize wireless technology for communication, such as, but are not limited to, Bluetooth (including BLE), Wi-Fi (including Wi-Fi Direct), Zigbee, Z-Wave, 6LoWPAN, Near-Field Communication, other types of electromagnetic radiation of a radio frequency wave, light-based communications (including infrared), acoustic communications, and any other type of peer-to-peer technology. The communication component 304 of the device components 300 may also utilize wired technology for communication, such as transmission of data over a physical conduit, e.g., an electrical cable or optical fiber cable.

The one or more processors 306 may execute code and process data received at other components of the device components 300, such as information received at the communication component 304 or stored at the memory component 308. The code associated with the building management system 100 and stored by the memory component 308 may include, but is not limited to, operating systems, applications, modules, drivers, and the like. An operating system includes executable code that controls basic functions of the mobile device 112, such as interactions among the various components of the device components 300, communication with external devices via the communication component 304, and storage and retrieval of code and data to and from the memory component 308. Each application includes executable code to provide specific functionality for the processor 306 and/or remaining components of the mobile device 112. Examples of applications executable by the processor 306 include, but are not limited to, building management applications, such as timing operations 310 based on clock data 206; device functions 312 such as the pseudo-random function 214 and key derivation function 218; encryption operations 314 for managing encryption 224 of the first plain text 210 to the first ciphertext 222; and the like. Data is information that may be referenced and/or manipulated by an operating system or application for performing functions of the mobile device 112. Examples of data associated with the building management system 100 and stored by the memory component 308 may include, but are not limited to, obfuscated ID data 316 such as the obfuscated identity key 204 and the obfuscated identification 212; key data 318 such as the root key 208 and the identity-based key 216; other device data 320 such as the beacon 202 including the first ciphertext 222 and the first plain text 210; and the like.

The device components 300 of each mobile device 112 may further comprise one or more input and/or output components (I/O interfaces) 322. The I/O interfaces 322 of the device components 300 may include one or more visual 324, audio 326, mechanical 328, and/or other components 330. The I/O interfaces 322 of each mobile device 112 may comprise a user interface 332 for interaction with a user of the mobile device 112. The user interface 332 may include a combination of hardware and software to provide a user with a desired user experience. For example, the user interface 332 may include one or more input components to allow the user to enter information and one or more output components to provide information to the user, such as a button 334 associated with an emergency or urgent condition being selected by a user at the mobile device 112 and an indicator to acknowledge selection of the button. Although the user interface 332 may include all input components and all output components of the I/O interface 322, the user interface may also be directed to a specific subset of input components and/or output components. The visual 324, audio 326, mechanical 328, and/or other components 330 of the I/O interfaces 322 may also manage sensor data received directly or indirectly from sensors of the mobile device 112. Examples of the sensor data managed by the I/O components 324-330 include, but are not limited to, lighting, motion, temperature, imaging, and air quality data associated with the mobile device 112.

The device components 300 may further comprise a power source 336, such as a power supply or a portable battery, for providing power to the other device components 300 of each mobile device 112 of the building management system 100.

It is to be understood that FIG. 3 is provided for illustrative purposes only to represent examples of the device components 300 of a mobile device 112 and is not intended to be a complete diagram of the various components that may be utilized by the device. Therefore, mobile device 112 may include various other components not shown in FIG. 3, may include a combination of two or more components, or a division of a particular component into two or more separate components, and still be within the scope of the present invention.

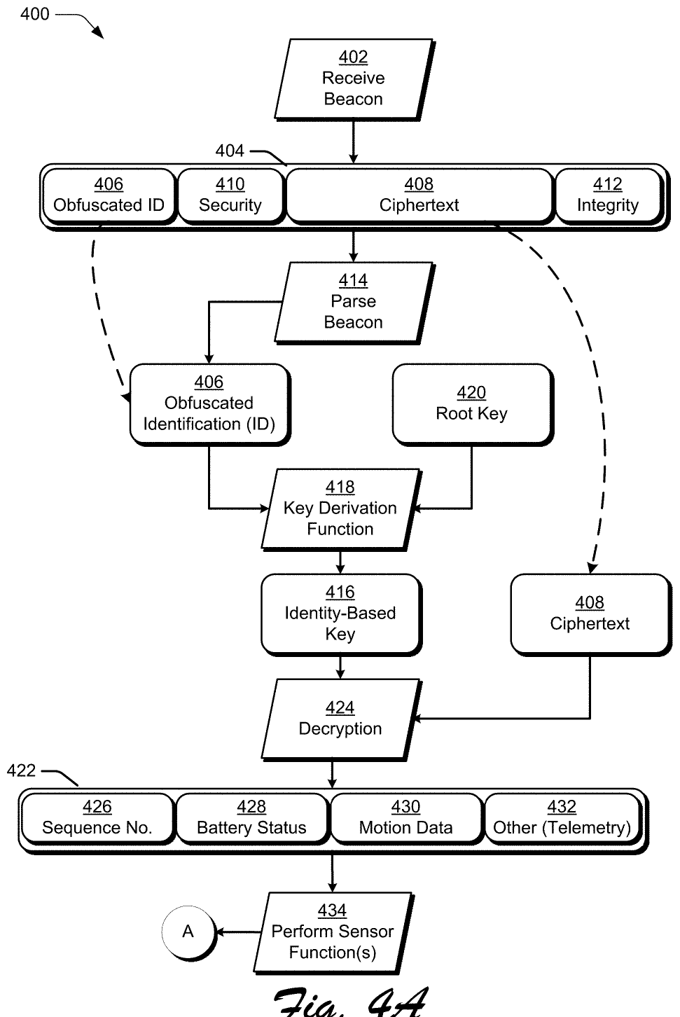

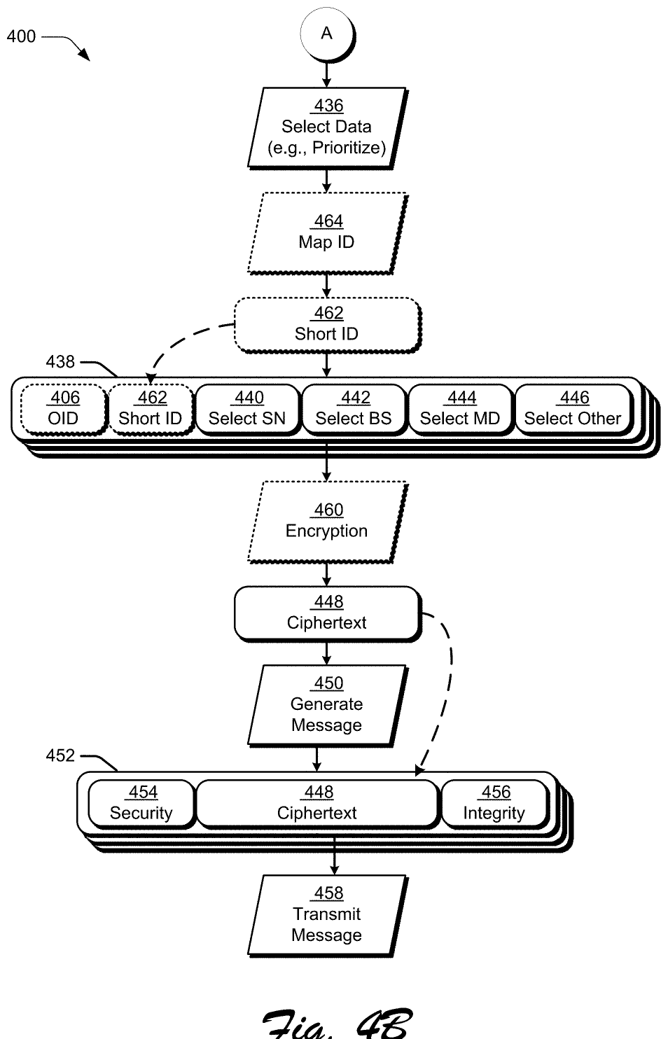

Referring to FIGS. 4A and 4B, there are shown flow diagrams depicting an example operation 400 of one or more intermediate devices of the building management system 100. The intermediate device, such as a sensor 114-124, decrypts beacon data of a received beacon by deriving a decryption key using the obfuscated identification and the root key. The intermediate device may then use the data for filtering, prioritization and other data handling while forwarding on data needed for computation to the remote server, such as in a remote location server or a cloud. For example, the intermediate device may prioritize telemetry data to ensure that urgent data is reported to the remote server, prioritize the sensors to report tracking data, transmit efficiently obfuscated identifications of mobile devices to reduce network usage and/or cloud processing, handle efficiently transmitted obfuscated identifications, and translate obfuscated identifications to real identities of the mobile devices.

Each intermediate device, such as the sensor 114-124, may receive 402 a beacon 404 from a mobile device 112 which includes the obfuscated identification 406 and the first ciphertext 408. The beacon 404 may also include other data to maintain the quality of the payload, such as security data 410 (e.g., nonce) to protect the payload and/or integrity data 412 (e.g., message integrity check) to minimize errors in the transported signal. The intermediate device may parse 414 the beacon 404 to extract the obfuscated identification 406 from the beacon 404 and determine the identity-based key 416 based on the extracted obfuscated identification. In particular, the intermediate device may apply a key derivation function 418 to determine the identity-based key 416 based on the obfuscated identification 406 and the root key 420. The intermediate device may determine the first plain text 422 from the first ciphertext 408 of the beacon 404 by applying decryption 424 using the identity-based key 416. Examples of standards that may be used for decryption include, but are not limited to, Advanced Encryption Standard, the Data Encryption Standard, or other specifications for the encryption of electronic data, such as AES128. The first plain text 422 may include various types of information that may be utilized by the intermediate devices and the remote server, such as for example beacon sequence numbers 426, battery statuses 428, motion data 430 (from an accelerometer of the mobile device), and other data 432 such as telemetry data or user input events (such as a button selection at the mobile device). The intermediate device may utilize one or more of the data of the first plain text 422 to perform one or more device functions 434, such as prioritization, filtering, and other functions to manage and control the operation of the intermediate device.

Referring to FIG. 4B, the intermediate device, such as a sensor 114-124, forwards the first cipher text 408 and/or the first plain text 422, or a modified version of the first cipher text and/or the first plain text, to the remote server 126-130. For some embodiments, a second ciphertext transmitted from the intermediate device to the remote server 126-130 may be based on a plain text of the first ciphertext 404 received from the mobile device 112. The intermediate device may generate a report that includes a second plain text originating from the first plain text. Thus, a second plain text associated with the second ciphertext is similar to the first plain text 422 associated with the first ciphertext. For other embodiments, the intermediate device may determine a second plain text based in part on the first plain text 422, in which the second plain text is different from the first plain text and the second ciphertext is determined based on the second plain text. Thus, the second plain text may be different from the first plain text, and the second ciphertext may be different from the first ciphertext. For these embodiments, other modifications by the intermediate device may differentiate the second plain text and ciphertext from the first plain text and ciphertext. For example, the grouping of data from multiple beacons received from the mobile device or devices 112 into associated data for a single report to the remote server 126-130, i.e., the message includes data originating from multiple beacons received from the mobile device(s).

As shown in FIG. 4B, for some embodiments, the intermediate device may select 436, such as prioritize or filter, the data of the first plain text 422 and generate a second plain text 438 based on modifications to the first plain text. The intermediate device may generate a report that includes the second plain text 438 in which one or more data of the second plain text may be modified versions of their counterparts in the first plain text 422, such as a select beacon sequence number 440, a select battery status 442, a select motion datum 444, and/or select other data 446. The report may also include, or be associated with, the obfuscated identification 406 of the received beacon 404. Whether modified or not, a second ciphertext 448 may be generated from the second plain text 438, and the intermediate device may generate 450 a message 452 including the second ciphertext 448. Similar to the beacon, the message 452 may also include other data to maintain the quality of the payload, such as security data 454 and/or integrity data 456. Thereafter, the intermediate device may transmit 458 the message 452 to the remote server 126-130 based on the prioritization and/or filtering selected 436 by the intermediate device. It is to be noted that the intermediate device may group multiple first plain texts 422 into a single second plain text 438. In such case, since the second ciphertext 448 is generated based on the second plain text 438 so the second ciphertext would include multiple first plain texts 422, thus be different from the first ciphertext 408.

The intermediate device includes encryption to protect the contents of the transmitted report 452 as well as other features to enhance the communication of the report to the remote server 126-130. For example, the intermediate device may encrypt 460 the report, such as or including the second plain text 438, with an encryption technique, such as a transport-level encryption, based on the security functions of the remote server 126-130, which may or may not be similar to an encryption technique utilized by the mobile device 112. For another example, the intermediate device may reduce available bandwidth for communications with the remote server 126-130 by utilizing short identification(s) 462. The short identification 462 may be shorter than the obfuscated identification 406. Transmitting cryptographically strong obfuscated identifications may require substantial network bandwidth for asset tracking at scale. Thus, the intermediate device may generate a short identification (“short ID”) for a given obfuscated identification and send a mapping of the short identification to the obfuscated identification to the cloud. Thereafter, the intermediate device may transmit short identifications to the cloud instead of the longer obfuscated identifications, thus allowing better use of bandwidth. The cloud translates the short identifications back to obfuscated identifications. In particular, the intermediate device may generate the short identification 462 and map 464 the short identification to the obfuscated identification 406. Initially, the intermediate device may send both the short identification 462 and the obfuscated identification 406 to the remote server 126-130 so that the remote server may associate the short identification with the obfuscated identification for any future communication. Thereafter, the intermediate device may send just the obfuscated identification 406, without the obfuscated identification, to the remote server 126-130.

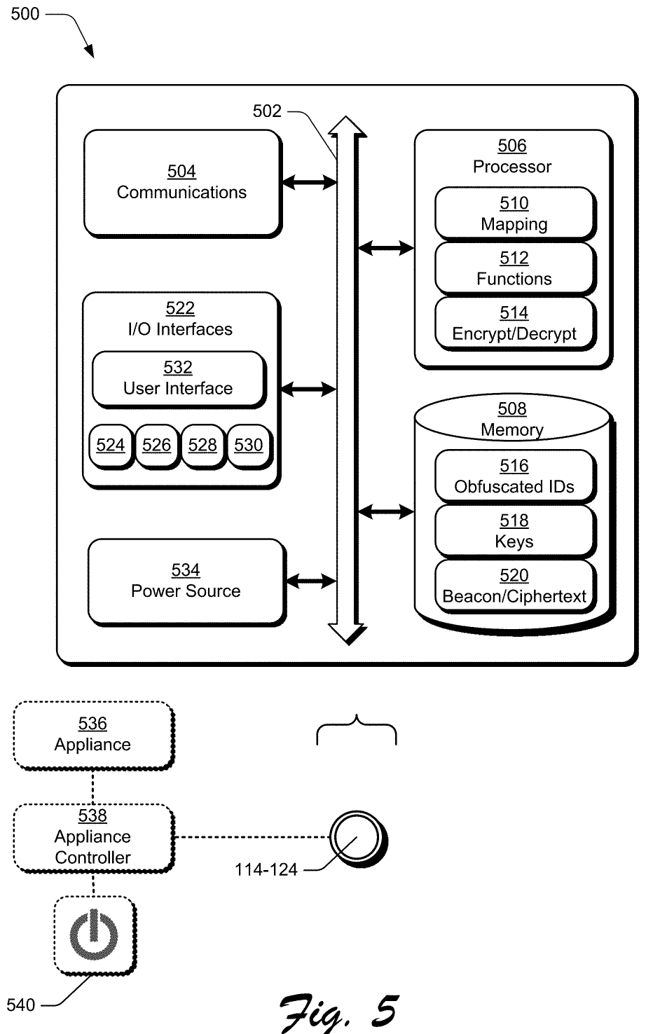

FIG. 5 represents example device components 500 of the intermediate device of the building management system 100. An example of an intermediate device includes, but is not limited to, a sensor 114-124 that includes wireless communication capabilities for receiving beacons, wired or wireless communication capabilities for transmitting reports (i.e., plain texts) or messages (i.e., ciphertexts) to the remote server 126-130, and processing capabilities to determine identity-based keys, decrypt ciphertexts, perform sensor functions, and generate the messages. The device components 500 of the intermediate device comprise a communication bus 502 for interconnecting the other device components directly or indirectly, one or more communication components 504 communicating with other entities via a wired or wireless network, one or more processors 506, and one or more memory components 508. The communication component(s) 504 may utilize wireless technology for communication, such as, but are not limited to, Bluetooth (including BLE), Wi-Fi (including Wi-Fi Direct), Zigbee, Z-Wave, 6LoWPAN, Near-Field Communication, other types of electromagnetic radiation of a radio frequency wave, light-based communications (including infrared), acoustic communications, and any other type of peer-to-peer technology. The communication component(s) 504 of the device components 500 may also utilize wired technology for communication, such as transmission of data over a physical conduit, e.g., an electrical cable or optical fiber cable.

The processor 506 may execute code and process data received other components of the device components 500, such as information received at the communication component 504 or stored at the memory component 508. The code associated with the building management system 100 and stored by the memory component 508 may include, but is not limited to, operating systems, applications, modules, drivers, and the like. An operating system includes executable code that controls basic functions of the intermediate device, such as interactions among the various components of the device components 500, communication with external devices via the communication component 504, and storage and retrieval of code and data to and from the memory component 508. Each application includes executable code to provide specific functionality for the processor 506 and/or remaining components of the intermediate device. Examples of applications executable by the processor 506 include, but are not limited to, building management applications, such as mapping operations 510 for correlating short identifications 462 with obfuscated identifications 408; device functions 512 such as the parsing function 414, key derivation function 418, performing sensor functions 434, and generating messages 450; encryption/decryption operations 514 for decrypting 424 the first plain text 422 from the first ciphertext 408 and, if necessary, encrypting 460 the second ciphertext 448 based on the second plain text 438; and the like. Data is information that may be referenced and/or manipulated by an operating system or application for performing functions of the intermediate device. Examples of data associated with the building management system 100 and stored by the memory component 508 may include, but are not limited to, obfuscated ID data 516 such as the obfuscated identification 406 and the short identification 462; key data 518 such as the root key 420 and the identity-based key 416; other device data 520 such as the beacon 404 including the first ciphertext 408, the first plain text 422, the second plain text 438, the message 452 including the second ciphertext 448, and the map identification data 464; and the like.

The device components 500 of each intermediate device may include one or more input and/or output components (I/O interfaces) 522. The I/O interfaces 522 of the device components 500 may include one or more visual 524, audio 526, mechanical 528, and/or other components 530. For some embodiments, the I/O interfaces 522 of each intermediate device may comprise a user interface 532 for interaction with a user of the intermediate device. The user interface 532 may include a combination of hardware and software to provide a user with a desired user experience. For example, the user interface 532 may include one or more input components to allow the user to enter information and one or more output components to provide information to the user, such as an indicator to show an operational status of the intermediate device. Although the user interface 532 may include all input components and all output components of the I/O interface 522, the user interface 532 may also be directed to a specific subset of input components and/or output components. The visual 524, audio 526, mechanical 528, and/or other components 530 of the I/O interfaces 522 may also manage sensor data received directly or indirectly from sensors of the intermediate device. Examples of the sensor data managed by the I/O components 524-530 include, but are not limited to, lighting, motion, temperature, imaging, and air quality data associated with the intermediate device.

The device components 500 may further comprise a power source 534, such as a power supply or a portable battery, for providing power to the other device components 500 of each intermediate device of the building management system 100.

Each intermediate device, such as the sensors 114-124, may operate with an appliance 536, such as a light fixture (shown in FIG. 1 as one or environmental devices 104-108). In order to operate with the appliance 536, the intermediate device may be coupled to an appliance controller 538 that interfaces with the appliance and allows the intermediate device to control one or more functions of the appliance 536. The appliance controller 538 may also couple to a power source 540 to provide power to the intermediate device, the appliance 536, and/or itself. When the intermediate device performs a sensor function 434, then the sensor function may include operation of one or more functions of an associated appliance 536.

It is to be understood that FIG. 5 is provided for illustrative purposes only to represent examples of the device components 500 of an intermediate device and is not intended to be a complete diagram of the various components that may be utilized by the device. Therefore, intermediate device may include various other components not shown in FIG. 5, may include a combination of two or more components, or a division of a particular component into two or more separate components, and still be within the scope of the present invention.

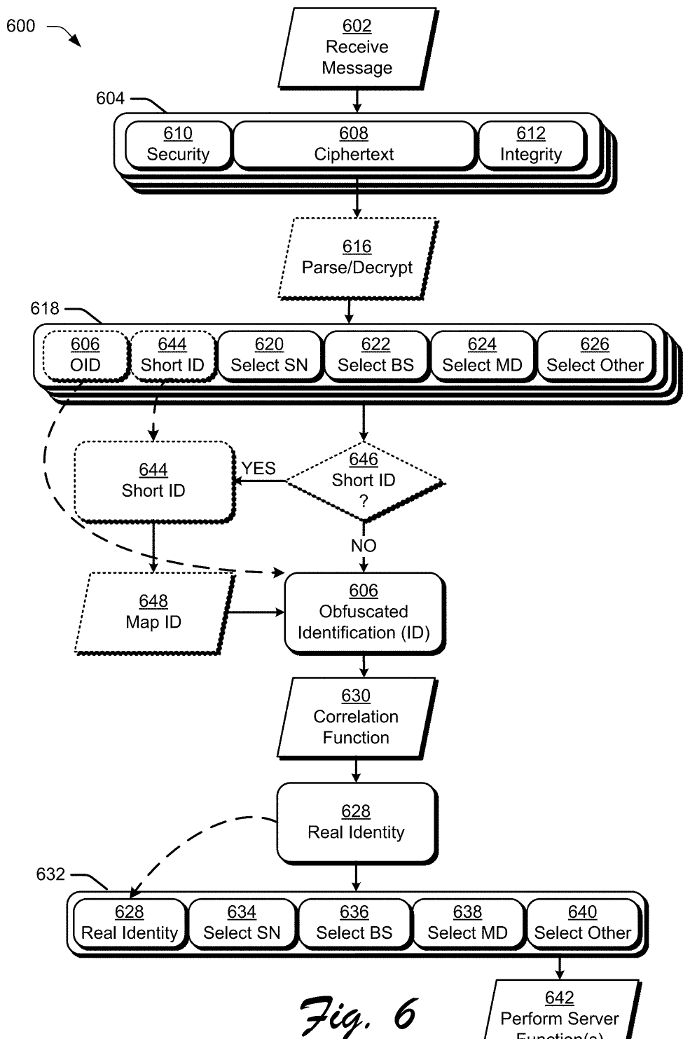

Referring to FIG. 6, there is shown a flow diagram depicting an example operation of the remote server of FIG. 1 to employ the techniques described herein. The remote server 126-130 may be a server 126 located at a particular area of the facility or a cloud 128 external to the facility that includes multiple servers 130 communicating with the intermediate devices 114-124 via a communications network.

Each remote server 126-130 may receive 602 a message 604 from an intermediate device 114-124 which includes the obfuscated identification 606 and the second ciphertext 608. The message 604 may also include other data to maintain the quality of the payload, such as security data 610 (e.g., nonce) and/or integrity data 612 (e.g., message integrity check) as well as the efficiency of the communication, such as a short identification received from the intermediate device. The remote server 126-130 may parse and/or decrypt 616 the message 604 to extract the obfuscated identification 606 from the message 604. The remote server 126-130 may include encryption to protect the contents of the received message 604 as well as other features to enhance the communication of the message 604 from the intermediate devices, such as the sensors 114-124. For example, the remote server 126-130 may decrypt 616 the message 604 with a decryption technique, such as a transport-level encryption, based on the security functions of the remote server 126-130, which may or may not be similar to the decryption technique utilized by the intermediate device 114-214 and/or the mobile device 112.

The remote server 126-130 may determine the second plain text 618 from the second ciphertext 608 of the message 604. The second plain text 618 may include various types of information that may be utilized by the remote server 126-130, such as for example the beacon sequence numbers 620, battery statuses 622, motion data 624, and other data 626 such as telemetry data or user input events (such as a button selection at the intermediate device). The remote server 126-130 may determine the real identity 628 of the mobile device 112 based on the extracted obfuscated identification 606 by applying a correlation function 630 to the obfuscated identification 606.

In response to determining the real identity 628, the remote server 126-130 may determine a measurement 632 based on the second plain text 618. The measurement 632 may include various types of information that may be utilized by the remote server 126-130, such as for example the real identity 628, beacon sequence numbers 634, battery statuses 636, motion data 638, and other data 640 such as telemetry data or user input events (such as a button selection at the intermediate device). The measurement 632 is similar to the second plain text 618 in which the measurement 632 includes, or is associated with, the real identity 628 instead of identification information received from the intermediate device, such as the obfuscated identification 606. One or more parts of data of the measurement 632 may be similar to data of the second plain text 618. For example, beacon sequence numbers 620, 634; battery statuses 622, 636; motion data 624, 638; and other data 626, 640 of the measurement 632 and the second plain text 618 may correspond to each other.

As stated above, the information as generated by the mobile device(s) 112 may or may not be modified by the intermediate devices 114-124. The remote server 126-130 may utilize one or more of the data of the second plain text 618 to perform 642 one or more server functions of the remote server. For example, the remote server 126-130 may determine the location of the mobile device 112 within the facility or the occupancy of one or more areas of the facility based on the real identity 628, the sequence number 634, the motion data 638, and other data 640 associated with telemetry information such as received signal strength indicator data between each mobile device and an intermediate device. For another example, battery status 636 may be reported by corresponding mobile device 112 so that the remote server 126-130 may perform a power management function at the server 126-130 or provide power management instructions to the mobile device 112 and/or one or more intervening devices, such as prioritizing low battery indications. As a further example, the other data 640 of the measurement 632 may indicate a button “user input” event which may necessitate emergency action by the remote server 126-130, such as contacting external emergency services and providing location information of the mobile device 112 to them.

The remote server 126-130 may utilize available bandwidth for communications with the intermediate device by utilizing short identifications 644. The short identification 644 may be shorter than the obfuscated identification 606. In particular, the remote server 126-130 may determine 646 whether the message 604 includes plain text having an obfuscated identification 606, a short identification 644, or both identifications. If the remote server 126-130 detects the obfuscated identification 606 solely, then the remote server 126-130 will process the plain text 618 of the message 604 based on the obfuscated identification 606. If the remote server 126-130 detects the obfuscated identification 606 and the short identification 644, then the remote server 126-130 will map 648 the short identification 644 to the obfuscated identification 606 for future reference and process the plain text 618 of the message 604 based on the obfuscated identification 606. If the remote server 126-130 detects the short identification 644 solely, then the remote server 126-130 will look up at the map 648 the short identification 644 to identify the corresponding obfuscated identification 606 and process the plain text 618 of the message 604 based on the obfuscated identification 606.

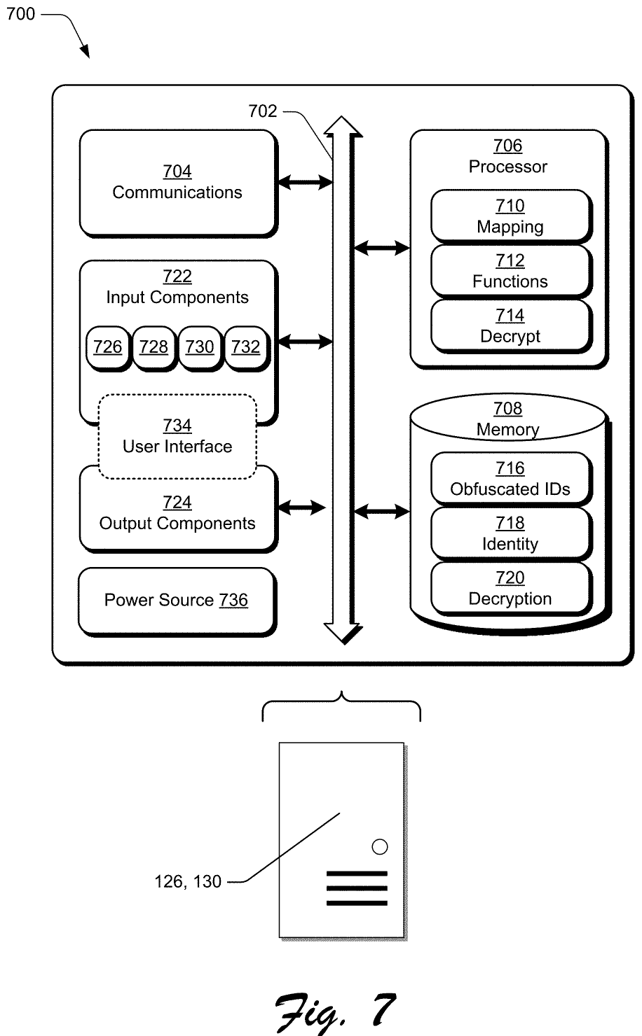

FIG. 7 represents example device components 700 of the remote server 126-130 of the building management system 100. An example of a remote server includes, but is not limited to, a server, a group of servers (such as a cloud), a desktop computer, a portable computer, a mobile device, and any other type of computing device including circuitry for wired or wireless communications and security functions. The device components 700 of the remote server 126-130 comprise a communication bus 702 for interconnecting the other device components directly or indirectly, one or more communication components 704 communicating other entities via a wired or wireless network, one or more processors 706, and one or more memory components 708. The communication component(s) 704 may utilize wireless technology for communication, such as, but are not limited to, Bluetooth (including BLE), Wi-Fi (including Wi-Fi Direct), Zigbee, Z-Wave, 6LoWPAN, Near-Field Communication, other types of electromagnetic radiation of a radio frequency wave, light-based communications (including infrared), acoustic communications, and any other type of peer-to-peer technology. The communication component(s) 704 of the device components 700 may also utilize wired technology for communication, such as transmission of data over a physical conduit, e.g., an electrical cable or optical fiber cable.

The processor 706 may execute code and process data received other components of the device components 700, such as information received at the communication component(s) 704 or stored at the memory component 708. The code associated with the building management system 100 and stored by the memory component 708 may include, but is not limited to, operating systems, applications, modules, drivers, and the like. An operating system includes executable code that controls basic functions of the remote server 126-130, such as interactions among the various components of the device components 700, communication with external devices via the communication component 704, and storage and retrieval of code and data to and from the memory component 708. Each application includes executable code to provide specific functionality for the processor 706 and/or remaining components of the intermediate device. Examples of applications executable by the processor 706 include, but are not limited to, building management applications, such as mapping operations 710 for correlating short identifications 614 with obfuscated identifications 606; device functions 712 such as the parsing/decryption function 616, correlation function 630, and performing server functions 642; decryption operations 714 for decrypting 616 the second plain text 618 from the second ciphertext 608 or message 604; and the like. Data is information that may be referenced and/or manipulated by an operating system or application for performing functions of the intermediate device. Examples of data associated with the building management system 100 and stored by the memory component 708 may include, but are not limited to, obfuscated ID data 716 such as the obfuscated identification 606 and the short identification 644; identity data 718 such as the real identity 628; other device data 720 such as the message 604 including the second ciphertext 608, the second plain text 618, and the map identification data 648; and the like.

The device components 700 of remote server 126-130 may include one or more input components 722 and/or one or more output components 724. The input components 722 of the device components 700 may include one or more visual 726, audio 728, mechanical 730, and/or other components 732. For some embodiments, the input components 722 and the output components 724 of the remote server 126-1130 may comprise a user interface 734 for interaction with a user of the remote server. The user interface 734 may include a combination of hardware and software to provide a user with a desired user experience. For example, the user interface 734 may include one or more input components to allow the user to enter information and one or more output components to provide information to the user. Although the user interface 734 may include all input components 722 and all output components 724, the user interface may also be directed to a specific subset of input components and/or output components. The device components 700 may further comprise a power source 736, such as a power supply or a portable battery, for providing power to the other device components 700 of each intermediate device of the building management system 100.

It is to be understood that FIG. 7 is provided for illustrative purposes only to represent examples of the device components 700 of an intermediate device and is not intended to be a complete diagram of the various components that may be utilized by the device. Therefore, intermediate device may include various other components not shown in FIG. 7, may include a combination of two or more components, or a division of a particular component into two or more separate components, and still be within the scope of the present invention.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

What is claimed is:

1. A building management system for secure communications among multiple devices, the system comprising:
a mobile device configured to broadcast a beacon, the beacon including an obfuscated identification and a first ciphertext;
a sensor configured to receive the beacon from the mobile device, generate an identity-based key based on the obfuscated identification, determine a first plain text by decrypting the first ciphertext using the identity-based key, and perform at least one sensor function based on at least a portion of the first plain text; and
a remote server configured to receive a message from the sensor, generate a real identity based on the obfuscated identification, determine a second plain text based on the second ciphertext, and perform at least one server function based on the real identity and at least a portion of the second plain text, wherein the message including a second ciphertext based at least in part on the first plain text.

2. The building management system as described in claim 1, wherein the message includes data originating from a plurality of beacons received by the sensor from the mobile device.

3. The building management system as described in claim 1, wherein:
the sensor determines the second plain text based in part on the first plain text, the second plain text being different from the first plain text; and
the sensor determines the second ciphertext based on the second plain text.

4. The building management system as described in claim 1, wherein the sensor applies a key derivation function to generate the identity-based key based on the obfuscated identification and a root key stored commonly at the mobile device and the sensor.

5. The building management system as described in claim 1, wherein each of the first plain text and the second plain text includes at least one of a sequence number, a battery status, a motion datum, or a telemetry datum.

6. The building management system as described in claim 1, wherein:
the sensor maps the obfuscated identification to a short identification;
the short identification is shorter than the obfuscated identification; and
the message includes at least one of the obfuscated identification or the short identification.

7. A sensor of a building management system for secure communication from a mobile device to a remote server comprising:
a communication component configured to receive a beacon from the mobile device and transmit a message to the remote server, the beacon including an obfuscated identification and a first ciphertext, the message including a second ciphertext based at least in part on a plain text determined from the first ciphertext; and
a processor configured to generate an identity-based key based on the obfuscated identification, determine the plain text by decrypting the first ciphertext using the identity-based key, and perform at least one sensor function based on at least a portion of the plain text.

8. The sensor as described in claim 7, wherein the message includes data originating from a plurality of beacons received from the mobile device.

9. The sensor as described in claim 7, wherein:
the plain text is a first plain text;
the processor determines a second plain text based in part on the first plain text, the second plain text being different from the first plain text; and
the processor determines a second ciphertext based on the second plain text.

10. The sensor as described in claim 7, further comprising a memory component configured to store a root key, wherein the processor generates the identity-based key based on the obfuscated identification and the root key.

11. The sensor as described in claim 7, wherein the processor generates the identity-based key by applying a key derivation function to the obfuscated identification and the root key.

12. The sensor as described in claim 7, wherein the plain text includes at least one of a sequence number, a battery status, a motion datum, or a telemetry datum.

13. The sensor as described in claim 7, wherein:
the processor maps the obfuscated identification to a short identification;
the short identification is shorter than the obfuscated identification; and
the message includes at least one of the obfuscated identification or the short identification.

14. A method of a sensor of a building management system for secure communication from a mobile device to a remote server, the method comprising:
receiving a beacon from the mobile device;
identifying an obfuscated identification and a first ciphertext from the beacon;
generating an identity-based key based on the obfuscated identification;
determining a plain text based on the first ciphertext, wherein determining the plain text includes decrypting the first ciphertext using the identity-based key;
performing at least one sensor function by the sensor based on at least a portion of the plain text; and
transmitting a message to the remote server, the message including a second ciphertext based at least in part on the plain text.

15. The method as described in claim 14, wherein the message includes data originating from a plurality of beacons received from the mobile device.

16. The method as described in claim 14, wherein the plain text is a first plain text and the method further comprises:
determining a second plain text based in part on the first plain text, the second plain text being different from the first plain text; and
determining the second ciphertext based on the second plain text.

17. The method as described in claim 14, wherein generating the identity-based key includes generating the identity-based key based on the obfuscated identification and a root key stored at the sensor.

18. The method as described in claim 14, wherein generating the identity-based key includes applying a key derivation function to the obfuscated identification and the root key.

19. The method as described in claim 14, wherein the plain text includes at least one of a sequence number, a battery status, a motion datum, or a telemetry datum.

20. The method as described in claim 14, further comprising mapping the obfuscated identification to a short identification, wherein:
the short identification is shorter than the obfuscated identification, and
the message includes at least one of the obfuscated identification or the short identification.
